(19) United States
(12) Patent Application Publication
(10) Pub. No.: US 2021/0248498 A1
(43) Pub. Date: Aug. 12, 2021

(54) METHOD AND APPARATUS FOR TRAINING PRE-TRAINED KNOWLEDGE MODEL, AND ELECTRONIC DEVICE

(71) Applicant: BEIJING BAIDU NETCOM SCIENCE AND TECHNOLOGY CO., LTD., Beijing (CN)

(72) Inventors: Chao PANG, Beijing (CN); Shuohuan WANG, Beijing (CN); Yu SUN, Beijing (CN); Zhi LI, Beijing (CN)

(73) Assignee: BEIJING BAIDU NETCOM SCIENCE AND TECHNOLOGY CO., LTD.

(21) Appl. No.: 17/241,999

(22) Filed: Apr. 27, 2021

(30) Foreign Application Priority Data
Dec. 21, 2020 (CN) 202011520100.9

(51) Int. Cl. G06N 5/04; G06F 40/30; G06N 20/00

(52) U.S. Cl. CPC G06N 5/04; G06N 20/00; G06F 40/30

(57) ABSTRACT

A method for training a pre-trained knowledge model includes: obtaining a training text, in which the training text includes a structured knowledge text and an article corresponding to the structured knowledge text, and the structured knowledge text includes a head node, a tail node, and a relationship between the head node and the tail node; and training a pre-trained knowledge model to be trained according to the training text.

### CROSS REFERENCE TO RELATED APPLICATION

This application is based upon and claims a priority to Chinese Patent Application Serial No. 202011520100.9, filed with the State Intellectual Property Office of P.R. China on Dec. 21, 2020, the entire contents of which are incorporated herein by reference.

### TECHNICAL FIELD

The present disclosure relates to a field of voice, natural language processing (NLP) and deep learning (DL) technology in the computer technology field, and particularly relates to a method and an apparatus for training a pre-trained knowledge model, an electronic device, a storage medium and a computer program product.

### BACKGROUND

At present, most models do not have a commonsense reasoning ability. For example, if a question is “What can be used to copy a document on a paper with ink?”, its answer may include a pen, a photocopier, a copying paper (i.e., a carbon paper), and a notebook. People may choose the correct answer “a photocopier” based on their common sense. However, due to a high frequency co-occurrence of “a copying paper” with the “copy” and “paper” in the question, the model is likely to choose the answer “a copying paper”, which leads to outputting a wrong result by the model. In the method for training a model in the related art, since joint training of commonsense learning and semantic learning may not be achieved, and the model gain is limited to the sample quality, the model often tends to be retrained, with low flexibility.

### SUMMARY

According to a first aspect, a method for training a pre-trained knowledge model is provided. The method includes: obtaining a training text, in which the training text includes a structured knowledge text and an article corresponding to the structured knowledge text, and the structured knowledge text includes a head node, a tail node, and a relationship between the head node and the tail node; and training a pre-trained knowledge model to be trained according to the training text.

According to a second aspect, an electronic device is provided. The electronic device includes: at least one processor; and a memory communicatively coupled to the at least one processor. The at least one processor is configured to obtain a training text, wherein the training text comprises a structured knowledge text and an article corresponding to the structured knowledge text, wherein the structured knowledge text comprises a head node, a tail node, and a relationship between the head node and the tail node; and train a pre-trained knowledge model to be trained according to the training text.

According to a third aspect, a non-transitory computer-readable storage medium having computer instructions stored thereon is provided. The computer instructions are configured to cause a computer to execute the method for training a pre-trained knowledge model according to the first aspect of the present disclosure.

It should be understood that, the content described in the part is not intended to identify key or important features of embodiments of the present disclosure, nor intended to limit the scope of the present disclosure. Other features of the present disclosure will be easy to understand through the following specification.

### BRIEF DESCRIPTION OF THE DRAWINGS

The drawings herein are intended to better understand the solution, and do not constitute a limitation to the disclosure.

FIG. 1 is a flowchart illustrating a method for training a pre-trained knowledge model according to a first embodiment of the present disclosure;

FIG. 2 is a flowchart illustrating obtaining a training text in a method for training a pre-trained knowledge model according to a second embodiment of the present disclosure;

FIG. 3 is a diagram illustrating training a pre-trained knowledge model to be trained according to the training text in the method for training a pre-trained knowledge model in a third embodiment of the present disclosure;

FIG. 4 is a block diagram illustrating an apparatus for training a pre-trained knowledge model according to a first embodiment of the present disclosure;

FIG. 5 is a block diagram illustrating an apparatus for training a pre-trained knowledge model according to a second embodiment of the present disclosure;

FIG. 6 is a block diagram illustrating an electronic device configured to implement a method for training a pre-trained knowledge model in the embodiment of the present disclosure.

### DETAILED DESCRIPTION

The exemplary embodiments of the present disclosure are described as below with reference to the accompanying drawings, which include various details of embodiments of the present disclosure to facilitate understanding, and should be considered as merely exemplary. Therefore, those skilled in the art should realize that various changes and modifications may be made to the embodiments described herein without departing from the scope of the present disclosure. Similarly, for clarity and conciseness, descriptions of well-known functions and structures are omitted in the following descriptions.

Voice may be applied to many technology fields such as a voice recognition and a voice interaction, which is an important direction in the field of artificial intelligence.

The Voice Recognition is a technology where a machine is configured to convert a voice signal into a corresponding text or command through recognition and understanding process, which mainly includes a feature extraction technology, a pattern matching criteria technology and a model training technology.

The Voice Interaction is a technology where a machine and a user perform interactive behaviors such as interaction, communication and information exchange with the voice as an information carrier. Compared with a traditional man-machine interaction, it is convenient and efficient, with high user comfort.

The Natural Language Processing (NLP) is a science that studies a computer system capable of effectively achieving natural language communication, especially a software system, which is an important direction in the field of computer science and artificial intelligence.

The Deep Learning (DL) is a new research direction in the field of Machine Learning (ML), which is a science that learns inherent law and representation hierarchy of sample data, so that the machine may have an analytic learning ability like humans and recognize data such as texts, images and sound, which is widely applied in the voice and image recognition.

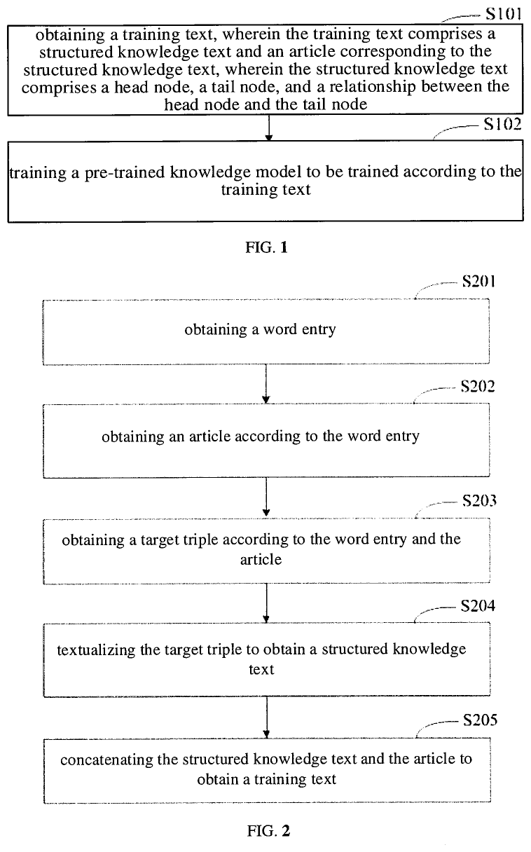

FIG. 1 is a flowchart illustrating a method for training a pre-trained knowledge model according to a first embodiment of the present disclosure.

As illustrated in FIG. 1, a method for training a pre-trained knowledge model according to a first embodiment of the present disclosure includes the blocks S101-S102.

In block S101, a training text is obtained, in which the training text includes a structured knowledge text and an article corresponding to the structured knowledge text, and the structured knowledge text includes a head node, a tail node, and a relationship between the head node and the tail node.

It should be noted that, an execution subject of the method for training a pre-trained knowledge model in the embodiments of the present disclosure may be a hardware device with the data information processing ability and/or a software required to drive the hardware device. Optionally, an execution subject may include a workstation, a server, a computer, a user terminal and other smart devices. The user terminal herein includes but not limited to a mobile phone, a computer, a smart voice interaction device, a smart appliance, a vehicle-mounted terminal, etc.

In the embodiments of the present disclosure, a large number of training texts are obtained to train a pre-trained knowledge model to be trained. The training text includes a structured knowledge text and an article corresponding to the structured knowledge text.

In the embodiments of the present disclosure, the structured knowledge text includes a head node, a tail node, and a relationship between the head node and the tail node, with clear semantic information.

For example, a structured knowledge text may be “Zhang San graduate university Huazhong University of Science and Technology”, in which the head node is Zhang San, the tail node is Huazhong University of Science and Technology, and the relationship between the head node and the tail node is graduate university. A piece of clear semantic information may be obtained through the structured knowledge text, that is, Zhang San's graduate university is Huazhong University of Science and Technology.

Alternatively, a structured knowledge text may be “Zhang San friend Li Si”, in which the head node is Zhang San, the tail node is Li Si, and the relationship between the head node and the tail node is friend. A piece of clear semantic information may be obtained through the structured knowledge text, that is, Li Si is Zhang San's friend.

It may be understood that, a structured knowledge text may further be expressed in any other kind of knowledge text with clear semantic information, which will not be limited here.

In the embodiment of the present disclosure, a structured knowledge text has a corresponding relationship with an article, i.e., a structured knowledge text may correspond to at least one article, and one article may correspond to at least one structured knowledge text. It should be noted that, in the embodiments of the present disclosure, content and form of an article are not be limited, which may be obtained through network and books, for example, an article corresponding to a structured knowledge text may be obtained through network search.

For example, when the structured knowledge text is “Zhang San friend Li Si”, an article with the semantic information “Li Si is Zhang San's friend” may be obtained through the network search. Alternatively, when the structured knowledge text is “Jiangsu provincial capital Nanjing”, an article with the semantic information “Jiangsu's provincial capital is Nanjing” may be obtained through the network search.

In block S102, a pre-trained knowledge model to be trained is trained according to the training text.

In the related art, a training entity is mostly embedded in a pre-trained knowledge model to be trained to achieve the learning of commonsense knowledge. However, said method requires to perform a pre-training on the pre-trained knowledge model with a method such as TransE, and then mix together during training process of the pre-trained knowledge model, which may not achieve the joint training of commonsense knowledge and semantic knowledge and is difficult to fully learn rich contextual information of the training entity. The performance gain of the pre-trained knowledge model is limited by embedding quality of the training entity, and a pre-trained knowledge model often tends to be retrained due to the static training entity.

In the embodiments of the present disclosure, a pre-trained knowledge model to be trained may be trained according to the training text, in which the training text includes a structured knowledge text and an article corresponding to the structured knowledge text. It may be understood that, a structured knowledge text has clear semantic information, but lacks rich language representation information, while an article has rich language representation information, but lacks clear semantic information. According to the training sample composed of the structured knowledge text and the article corresponding to the structured knowledge text, a pre-trained knowledge model to be trained is trained, so that the pre-trained knowledge model to be trained learns both commonsense knowledge and rich semantic knowledge, which achieves the joint training of commonsense knowledge and semantic knowledge.

Moreover, a training entity doesn't need to be embedded into a pre-trained knowledge model to be trained in the described-above method, performance gain of the pre-trained knowledge model is not limited by embedding quality of the training entity, and the pre-trained knowledge model may obtain abundant contextual information from the article in the training text and make dynamic adjustment with high flexibility.

Optionally, a pre-trained knowledge model to be trained may be configured according to actual situation.

In summary, according to the method for training a pre-trained knowledge model in the embodiment of the present disclosure, a training text is obtained, in which the training text includes a structured knowledge text and an article corresponding to the structured knowledge text, and the structured knowledge text includes a head node, a tail node, and a relationship between the head node and the tail node, and a pre-trained knowledge model to be trained is trained according to the training text. Thus, the pre-trained knowledge model to be trained may learn commonsense knowledge and rich semantic knowledge simultaneously to achieve the joint training of commonsense knowledge and semantic knowledge, and does not need to embed a training entity into the pre-trained knowledge model to be trained. Performance gain of the pre-trained knowledge model is not limited by embedding quality of the training entity, which may obtain abundant contextual information from the article in the training text and make dynamic adjustment with high flexibility.

On the basis of any above embodiment, as illustrated in FIG. 2, obtaining a training text at block S101 includes the blocks S201-S205.

In block S201, a word entry is obtained.

In the embodiment of the present disclosure, a large number of word entries may be obtained, to obtain a large number of training texts.

It should be noted that, in the embodiment of the present disclosure, content and form of word entries are not limited, for example, a word entry includes but not limited to a person name, a place name, etc., for example, Zhang San, Beijing, Summer Palace, etc.

In block S202, an article is obtained according to the word entry.

In the embodiments of the present disclosure, a word entry has a corresponding relation with an article, a word entry may correspond to at least one article, and an article may correspond to at least one word entry.

Optionally, obtaining an article according to the word entry may include searching the word entry through the network and obtaining an article from the network search results corresponding to the word entry. For example, when a word entry is Zhang San, Zhang San may be searched as a search word on a certain website, and its corresponding article is obtained from the search result corresponding to the word entry.

Optionally, obtaining the article according to the word entry may include obtaining at least one candidate article according to the word entry, obtaining the relevance of each candidate article to the word entry, and taking the candidate article with the highest relevance as an article corresponding to the word entry. An article with the highest entry relevance may be screened from multiple articles as an article corresponding to the word entry.

In block S203, a target triple is obtained according to the word entry and the article.

Optionally, obtaining a target triple according to the word entry and the article may include obtaining a candidate triple with a head node being the word entry from a Knowledge Graph (KG), and determining a candidate triple with a tail node appearing in the article as the target triple. The candidate triple includes a head node, a tail node, and a relationship between the head node and the tail node.

It may be understood that, the candidate triple may be obtained from the KG by using the word entry as a head node, that is, a head node of the candidate triple is the word entry. For example, when a word entry is Zhang San, a head node of the corresponding candidate triple is Zhang San.

Therefore, in the method, a target triple whose head node is the word entry and whose tail node appears in the article may be screened from the KG.

Optionally, the KG may be configured according to actual situation.

In block S204, a target triple is textualized to obtain a structured knowledge text.

It may be understood that a target triple doesn't have a text structure, a target triple may be textualized to obtain a structured knowledge text.

Optionally, textualizing a target triple i to obtain a structured knowledge text may include textualizing the target triple according to a preset textualization rule to obtain the structured knowledge text. The preset textualization rule may be configured according to actual situation.

For example, if a target triple is (Zhang San, friend, Li Si), the corresponding structured text may be Zhang San friend Li Si, and if a target triple is (Jiangsu, provincial capital, Nanjing), the corresponding structured text may be Jiangsu provincial capital Nanjing.

It should be noted that, a target triple textualization may be in other forms, which will not limited here.

In block S205, a structured knowledge text and an article may be concatenated to obtain a training text.

Optionally, concatenating a structured knowledge text and an article may include concatenating a structured knowledge text to a preset position of the article. The preset position may be configured according to actual situation, including but not limited to date, position of a tail node in the article, which will not be limited here.

Thus, in this method, an article may be obtained according to a word entry, and a target triple is obtained according to the word entry and an article, a target triple is textualized to obtain a structured knowledge text, and the structured knowledge text and the article are concatenated to obtain a training text.

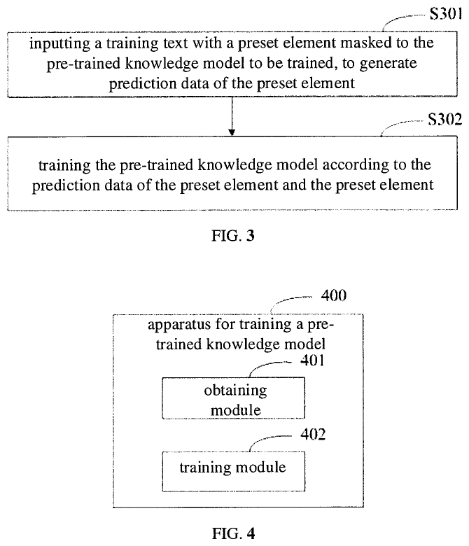

On the basis of any above embodiment, as illustrated in FIG. 3, training a pre-trained knowledge model to be trained according to the training text at block S102 includes the blocks S301-S302.

In block S301, a training text with a preset element masked is input to the pre-trained knowledge model to be trained, to generate prediction data of the preset element.

In the embodiments of the preset disclosure, the training text includes at least one preset element which is masked, and the training text with the preset element masked is input to the pre-trained knowledge model to be trained, to generate prediction data of the preset element.

It may be understood that, after the training text with the preset element masked is input to the pre-trained knowledge model to be trained, the preset element may be predicted through the pre-trained knowledge model to be trained, to obtain prediction data of the preset element.

Optionally, the preset element may be any one of the head node, the tail node, and the relationship in the structured knowledge text, or any one word in the article. It may be understood that, when the preset element is any one of the head node, the tail node, and the relationship in the structured knowledge text, or any one word in the article, so that the pre-trained knowledge model may learn commonsense knowledge, and when the preset element is any one word in the article, the pre-trained knowledge model may learn semantic knowledge.

For example, a training text is “Zhang San is 26 years old, Zhang San's graduate university is Huazhong University of Science and Technology, Huazhong University of Science and Technology is a university of science and technology, good at photography and video editing”. If a structured knowledge text is “Zhang San graduate university Huazhong University of Science and Technology”, the head node of the structured knowledge text is Zhang San, the tail node is Huazhong University of Science and Technology, and the relationship between the head node and the tail node is graduate university. The article is “Zhang San is 26 years old, his graduate university is Huazhong University of Science and Technology, Huazhong University of Science and Technology is a university of science and technology, good at photography and video editing”, a training text with a preset element masked includes but not limited to “Zhang San is 26 years old, [Mask] graduate university is Huazhong University of Science and Technology, Huazhong University of Science and Technology is a university of science and technology, good at photography and video editing”, “Zhang San is 26 years old, Zhang San [Mask] is Huazhong University of Science and Technology, Huazhong University of Science and Technology is a university of science and technology, good at photography and video editing”, “Zhang San is 26 years old, Zhang San's graduate university is [Mask], good at photography and video editing”, “Zhang San is 26 years old, graduate university Huazhong University of Science and Technology, Huazhong University of Science and Technology is [Mask], good at photography and video editing” etc.

In block S302, a pre-trained knowledge model to be trained is trained according to prediction data of the preset element and the preset element.

Optionally, there may be differences between the prediction data of a preset element and the preset element, a pre-trained knowledge model to be trained may be trained according to the differences until the pre-trained knowledge model converges, or the number of iterations reaches a preset threshold, or the model precision reaches a preset threshold, the training of the pre-trained knowledge model may be finished at this time, and the pre-trained knowledge model obtained from the last training is taken as a trained pre-trained knowledge model. The iteration number threshold and the precision threshold may be configured according to actual situations.

Thus, in the method, a training text with a preset element masked is input to the pre-trained knowledge model to be trained, to generate prediction data of the preset element, and the pre-trained knowledge model to be trained is trained according to the prediction data of the preset element and the preset element.

FIG. 4 is a block diagram illustrating an apparatus for training a pre-trained knowledge model according to a first embodiment of the present disclosure.

As illustrated in FIG. 4, an apparatus 400 for training a pre-trained knowledge model in the embodiment of the present disclosure includes an obtaining module 401 and a training module 402.

The obtaining module 401 is configured to obtain a training text, in which the training text includes a structured knowledge text and an article corresponding to the structured knowledge text, and the structured knowledge text includes a head node, a tail node, and a relationship between the head node and the tail node; the training module 402 is configured to train a pre-trained knowledge model to be trained according to the training text.

In an embodiment of the present disclosure, the training module 402 is configured to: input a training text with a preset element masked to the pre-trained knowledge model to be trained, to generate prediction data of the preset element; and train the pre-trained knowledge model to be trained according to prediction data of the preset element and the preset element.

In an embodiment of the present disclosure, the preset element is any one of the head node, the tail node, and the relationship in the structured knowledge text, or any one word in the article.

In summary, an apparatus for training a pre-trained knowledge model in the embodiment of the present disclosure, a training text is obtained, in which the training text includes a structured knowledge text and an article corresponding to the structured knowledge text, and the structured knowledge text includes a head node, a tail node, and a relationship between the head node and the tail node, and a pre-trained knowledge model to be trained is trained according to the training text. Thus, a pre-trained knowledge model to be trained may learn commonsense knowledge and rich semantic knowledge simultaneously to achieve the joint training of commonsense knowledge and semantic knowledge, and a training entity does not need to be embedded into a pre-trained knowledge model to be trained. Performance gain of a pre-trained knowledge model is not limited by embedding quality of the training entity, and the pre-trained knowledge model may obtain abundant contextual information from the article in the training text and make dynamic adjustment with high flexibility.

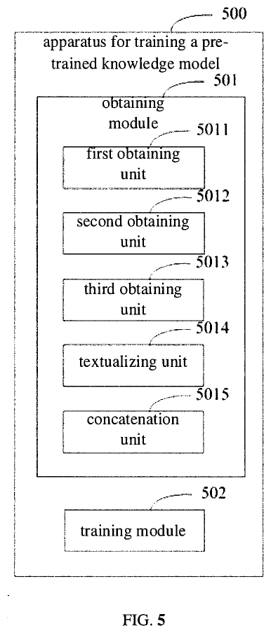

FIG. 5 is a block diagram illustrating an apparatus for training a pre-trained knowledge model according to a second embodiment of the present disclosure.

As illustrated in FIG. 5, an apparatus 500 for training a pre-trained knowledge model in the embodiment of the present disclosure includes: an obtaining module 501 and a training module 502. The training module 502 has the same function and structure with the training module 402.

In an embodiments of the present disclosure, the obtaining module 501 includes: a first obtaining unit 5011, configured to obtain a word entry; a second obtaining unit 5012, configured to obtain an article according to the word entry; a third obtaining unit 5013, configured to obtain a target triple according to the word entry and the article; a textualizing unit 5014, configured to textualize the target triple to obtain a structured knowledge text; a concatenation unit 5015, configured to concatenate the structured knowledge text and the article together to obtain a training text.

In an embodiment of the present disclosure, the third obtaining unit 5013 is configured to: obtain a candidate triple with a head node being the word entry from a knowledge graph (KG), in which the candidate triple includes a head node, a tail node and a relationship between the head node and the tail node; and determine a candidate triple corresponding to a tail node appearing in the article as the target triple.

In summary, an apparatus for training a pre-trained knowledge model in the embodiment of the present disclosure, a training text is obtained, in which the training text includes a structured knowledge text and an article corresponding to the structured knowledge text, and the structured knowledge text includes a head node, a tail node, and a relationship between the head node and the tail node, and a pre-trained knowledge model to be trained is trained according to the training text. Thus, a pre-trained knowledge model to be trained may learn commonsense knowledge and rich semantic knowledge simultaneously to achieve the joint training of commonsense knowledge and semantic knowledge, and a training entity does not need to be embedded into a pre-trained knowledge model to be trained, performance gain of a pre-trained knowledge model is not limited by embedding quality of the training entity, and the pre-trained knowledge model may obtain abundant contextual information from the article in the training text and make dynamic adjustment with high flexibility.

In the embodiment of the present disclosure, an electronic device, a readable storage medium and a computer program product are further provided according to embodiments of the present disclosure

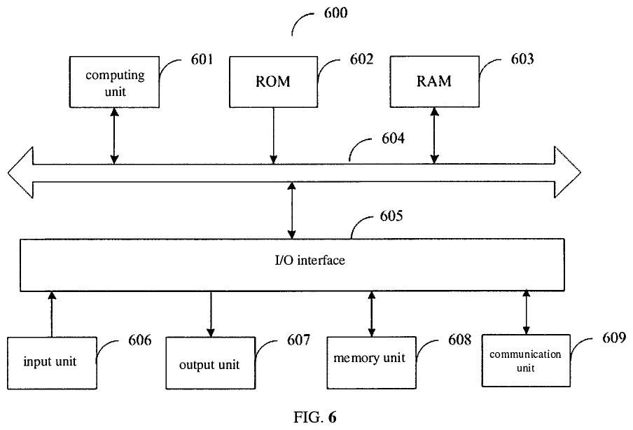

FIG. 6 is a schematic block diagram illustrating an example electronic device 600 in the embodiment of the present disclosure. An electronic device is intended to represent various types of digital computers, such as laptop computers, desktop computers, workstations, personal digital assistants, servers, blade servers, mainframe computers, and other suitable computers. An electronic device may also represent various types of mobile apparatuses, such as personal digital assistants, cellular phones, smart phones, wearable devices, and other similar computing devices. The components illustrated herein, their connections and relations, and their functions are merely examples, and are not intended to limit the implementation of the disclosure described and/or required herein.

As illustrated in FIG. 6, an electronic device 600 includes a computing unit 601, configured to execute various appropriate actions and processes according to a computer program stored in a read-only memory (ROM) 602 or loaded from a memory unit 608 to a random access memory (RAM) 603. In a RAM 603, various programs and data required for an electronic device 600 may be stored. A computing unit 601, a ROM 602 and a ROM 603 may be connected with each other by a bus 604. An input/output (I/O) interface 605 is also connected to a bus 604.

Multiple components in the electronic device 600 are connected to an I/O interface 605, and includes: an input unit 606, for example, a keyboard, a mouse, etc; an output unit 607, for example various types of displays, speakers; a memory unit 608, for example a magnetic disk, an optical disk; and a communication unit 609, for example, a network card, a modem, a wireless transceiver. A communication unit 609 allows an electronic device 600 to exchange information/data through a computer network such as internet and/or various types of telecommunication networks and other devices.

A computing unit 601 may be various types of general and/or dedicated processing components with processing and computing ability. Some examples of a computing unit 601 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. A computing unit 601 executes various methods and processes as described above, for example, a method for training a pre-trained knowledge model as described in FIG. 1 to FIG. 3. For example, in some embodiments, a method for training a pre-trained knowledge model may be further implemented as a computer software program, which is physically contained in a machine readable medium, such as a memory unit 608. In some embodiments, a part or all of the computer program may be loaded and/or installed on the electronic device 600 through a ROM 602 and/or a communication unit 609. When the computer program is loaded on a RAM 603 and executed by a computing unit 601, one or more blocks in the method for training a pre-trained knowledge model as described above may be performed. Alternatively, in other embodiments, a computing unit 601 may be configured to execute a method for training a pre-trained knowledge model in other appropriate methods (for example, by virtue of a firmware).

Various implementation modes of systems and technologies described herein may be implemented in a digital electronic circuit system, an integrated circuit system, a field programmable gate array (FPGA), a dedicated application specific integrated circuit (ASIC), a system on a chip (SOC), a load programmable logic device (CPLD), a computer hardware, a firmware, a software, and/or combinations thereof. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the present disclosure may be written with one or any combination of multiple programming languages. These programming languages may be provided to a processor or a controller of a general purpose computer, a dedicated computer, or other apparatuses for programmable data processing so that the function/operation specified in the flowchart and/or block diagram may be performed when the program code is executed by the processor or controller. A computer code may be executed completely or partly on the machine, executed partly on the machine as an independent software package and executed partly or completely on the remote machine or server.

In the context of the present disclosure, a machine-readable medium may be a tangible medium that may contain or store a program intended for use in or in conjunction with an instruction execution system, apparatus, or device. A machine-readable medium may be a machine readable signal medium or a machine readable storage medium. A machine readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a random access memory (RAM), a read-only memory (ROM), an erasable programmable read-only memory (an EPROM or a flash memory), an optical fiber device, and a portable optical disk read-only memory (CDROM), an optical storage device, a magnetic storage device, or any appropriate combination of the above.

In order to provide interaction with the user, the systems and technologies described here may be implemented on a computer, and the computer has: a display apparatus for displaying information to the user (for example, a CRT (cathode ray tube) or a LCD (liquid crystal display) monitor); and a keyboard and a pointing apparatus (for example, a mouse or a trackball) through which the user may provide input to the computer. Other types of apparatuses may further be configured to provide interaction with the user; for example, the feedback provided to the user may be any form of sensory feedback (for example, visual feedback, auditory feedback, or tactile feedback); and input from the user may be received in any form (including an acoustic input, a voice input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). Examples of communication networks include: a local area network (LAN), a wide area network (WAN), a blockchain network, and an internet.

The computer system may include a client and a server. The client and server are generally far away from each other and generally interact with each other through a communication network. The relationship between the client and the server is generated by computer programs that run on the corresponding computer and have a client-server relationship with each other. A server may be a cloud server, also known as a cloud computing server or a cloud host, is a host product in a cloud computing service system, to solve the shortcomings of large management difficulty and weak business expansibility existed in the traditional physical host and Virtual Private Server (VPS) service. A server further may be a server with a distributed system, or a server in combination with a blockchain.

According to an embodiment, a computer program product is further provided in the present disclosure, which includes a computer program, in which the computer program is configured to execute a method for training a pre-trained knowledge model as described when executed by a processor.

It should be understood that, various forms of procedures illustrated above may be configured to reorder, add or delete blocks. For example, blocks described in the present disclosure may be executed in parallel, sequentially, or in a different order, as long as the desired result of the technical solution disclosed in the present disclosure may be achieved, which will not be limited herein.

The above specific implementations do not constitute a limitation on the protection scope of the present disclosure. Those skilled in the art should understand that various modifications, combinations, sub-combinations and substitutions may be made according to design requirements and other factors. Any modification, equivalent replacement, improvement, etc., made within the spirit and principle of embodiments of the present disclosure shall be included within the protection scope of embodiments of the present disclosure.

What is claimed is:

1. A method for training a pre-trained knowledge model, comprising:
obtaining a training text, wherein the training text comprises a structured knowledge text and an article corresponding to the structured knowledge text, and the structured knowledge text comprises a head node, a tail node, and a relationship between the head node and the tail node; and
training a pre-trained knowledge model to be trained according to the training text.

2. The method of claim 1, wherein, training the pre-trained knowledge model to be trained according to the training text comprises:
inputting the training text with a preset element masked to the pre-trained knowledge model to be trained, to generate prediction data of the preset element;
training the pre-trained knowledge model to be trained according to the prediction data of the preset element and the preset element.

3. The method of claim 2, wherein, the preset element is any one of the head node, the tail node, and the relationship in the structured knowledge text, or any one word in the article.

4. The method of claim 1, further comprising:
obtaining a word entry;
obtaining an article according to the word entry;
obtaining a target triple according to the word entry and the article;
textualizing the target triple to obtain a structured knowledge text; and
concatenating the structured knowledge text and the article to obtain a training text.

5. The method of claim 4, wherein, obtaining the target triple according to the word entry and the article comprises:
obtaining candidate triples each with a head node being the word entry from a Knowledge Graph (KG), wherein, the candidate triple comprises a head node, a tail node and a relationship between the head node and the tail node; and
determining a candidate triple with a tail node appearing in the article from the candidate triples with the head node being the word entry as the target triple.

6. An electronic device, comprising:
at least one processor; and
a memory communicatively coupled to the at least one processor;
wherein the at least one processor is configured to:
obtain a training text, wherein the training text comprises a structured knowledge text and an article corresponding to the structured knowledge text, wherein the structured knowledge text comprises a head node, a tail node, and a relationship between the head node and the tail node; and
train a pre-trained knowledge model to be trained according to the training text.

7. The electronic device of claim 6, wherein the at least one processor is further configured to:
input the training text with a preset element masked to the pre-trained knowledge model to be trained, to generate prediction data of the preset element;
train a pre-trained knowledge model to be trained according to the prediction data of the preset element and the preset element.

8. The electronic device of claim 7, wherein the preset element is any one of the head node, the tail node, and the relationship in the structured knowledge text, or any one word in the article.

9. The electronic device of claim 6, wherein the at least one processor is further configured to:
obtain a word entry;
obtain an article according to the word entry;
obtain a target triple according to the word entry and the article;
textualize the target triple to obtain a structured knowledge text; and
concatenate the structured knowledge text and the article to obtain a training text.

10. The electronic device of claim 9, wherein the at least one processor is further configured to:
obtain candidate triples each with a head node being the word entry from a Knowledge Graph (KG), wherein, the candidate triple comprises a head node, a tail node and a relationship between the head node and the tail node; and
determine a candidate triple with a tail node appearing in the article from the candidate triples with the head node being the word entry as the target triple.

11. A non-transitory computer-readable storage medium having computer instructions stored thereon, wherein the computer instructions are configured to cause a computer to execute a method for training a pre-trained knowledge model, the method comprising:
obtaining a training text, wherein the training text comprises a structured knowledge text and an article corresponding to the structured knowledge text, and the structured knowledge text comprises a head node, a tail node, and a relationship between the head node and the tail node; and
training a pre-trained knowledge model to be trained according to the training text.

12. The storage medium of claim 11, wherein training the pre-trained knowledge model to be trained according to the training text comprises:
inputting the training text with a preset element masked to the pre-trained knowledge model to be trained, to generate prediction data of the preset element;
training the pre-trained knowledge model to be trained according to the prediction data of the preset element and the preset element.

13. The storage medium of claim 12, wherein, the preset element is any one of the head node, the tail node, and the relationship in the structured knowledge text, or any one word in the article.

14. The storage medium of claim 11, further comprising:
obtaining a word entry;
obtaining an article according to the word entry;
obtaining a target triple according to the word entry and the article;
textualizing the target triple to obtain a structured knowledge text; and
concatenating the structured knowledge text and the article to obtain a training text.

15. The storage medium of claim 14, wherein obtaining the target triple according to the word entry and the article comprises:
obtaining candidate triples each with a head node being the word entry from a Knowledge Graph (KG), wherein, the candidate triple comprises a head node, a tail node and a relationship between the head node and the tail node; and
determining a candidate triple with a tail node appearing in the article from the candidate triples with the head node being the word entry as the target triple.
